(19) United States
(12) Patent Application Publication
(10) Pub. No.: US 2013/0117149 A1
(43) Pub. Date: May 9, 2013

(54) SELECTIVE SHOPPING CART CHECKOUT

(71) Applicant: Vivek Gupta, Yarrow Point, WA (US)

(72) Inventor: Vivek Gupta, Yarrow Point, WA (US)

(73) Assignee: eBay Inc., San Jose, CA (US)

(21) Appl. No.: 13/291,022

(22) Filed: Nov. 7, 2011

(51) Int. Cl. G06Q 30/06

(52) U.S. Cl. 705/26.8

(57) ABSTRACT

An apparatus and method for selective checkout of items in a shopping cart is disclosed herein. One or more items placed in a shopping cart may be selected for purchase without emptying the shopping cart of the items that a user does not wish to purchase at that point in time. The items remaining in the shopping cart after checkout are automatically retained for future use by the user.

### TECHNICAL FIELD

The present application relates generally to systems and methods for electronic commerce, and in one specific example, to systems and methods for making electronic commerce purchases.

### BACKGROUND

In an electronic commerce marketplace, a user can navigate within the marketplace to obtain information about items (e.g., goods or services) being offered for sale and to purchase one or more of those items. As the user navigates within the site, he or she can add items of interest to a virtual shopping cart. When the user is ready to checkout, he/she completes a checkout process to purchase the items placed in the shopping cart.

As part of the checkout process, the user is typically offered the opportunity to view the items in the shopping cart. The user is also provided the opportunity to remove or edit (e.g., change the quantity or color) one or more items in the shopping cart prior to purchasing the items. The items remaining in the shopping cart can then be purchased by the user or the user may, for whatever reason, decline to place an order for the items in the shopping cart.

### BRIEF DESCRIPTION OF THE DRAWINGS

Some embodiments are illustrated by way of example and not limitations in the figures of the accompanying drawings.

FIG. 1 illustrates a network diagram depicting an exemplary client-server system according to some embodiments.

FIG. 2 illustrates a block diagram of additional details of applications included in the client-server system of FIG. 1.

FIG. 3 illustrates a block diagram showing modules included in the personalization applications of the client-server system of FIG. 1.

FIG. 4A illustrates an exemplary flow diagram for providing selective checkout of items in a shopping cart according to some embodiments.

FIG. 4B illustrates an exemplary flow diagram for subsequent access to non-selected items in a shopping cart according to some embodiments.

FIGS. 5A-5C shows various exemplary shopping cart pages displayed to a user according to some embodiments.

FIG. 6 shows a diagrammatic representation of a machine in the example form of a computer system within which a set of instructions, for causing the machine to perform any one or more of the methodologies discussed herein, may be executed.

The headings provided herein are for convenience only and do not necessarily affect the scope or meaning of the claimed invention.

### DETAILED DESCRIPTION

Described in detail below is an apparatus and method for placing items offered by an electronic marketplace into a virtual shopping cart as a user browses through items and certain items catches the user's interest. The user may add an item to the shopping cart for a variety of reasons such as, for example, because he or she wants to purchase the item, has an interest in the item but is not quite ready to purchase the item, a special is offered for the item, or the item has otherwise caught the user's attention. Thus, when the user is ready to checkout, the user may or may not want to buy everything in the shopping cart. By providing a selective purchase now feature in connection with contents of a user's shopping cart, the user may select item(s) from among the items placed in the shopping cart for immediate purchase rather than having to delete item(s) that the user is not ready to purchase at that point in time before checking out. The user then completes a purchase of only those item(s) that he/she is ready to buy and the remaining item(s) in the shopping cart are automatically saved in the shopping cart for later use by the user. With the selective purchase now feature, the user need not spend time removing items from the cart that he/she is not currently ready to buy before purchasing items he is ready to buy, nor does the user have to find the removed items again in a subsequent visit to the electronic marketplace if he is still interested in those items.

The following description is presented to enable any person skilled in the art to create and use a computer system configuration and related method and article of manufacture to selectively purchase one or more items in a virtual shopping cart provided by an electronic marketplace without removing the non-selected item(s) from the shopping cart. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

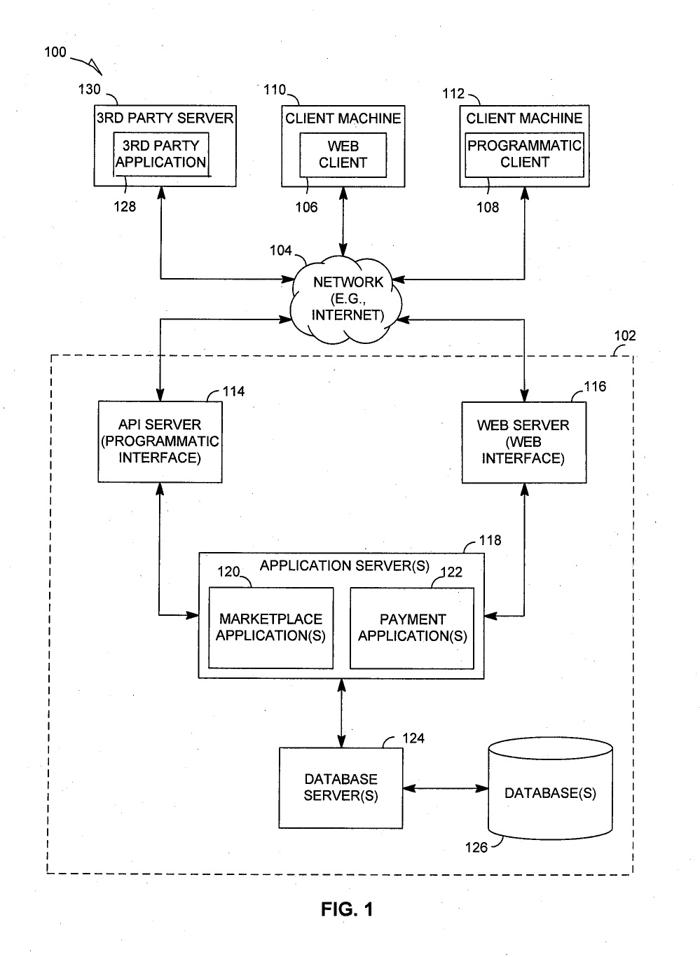

FIG. 1 illustrates a network diagram depicting an exemplary client-server system 100 for providing selective electronic commerce marketplace checkout according to some embodiments. A networked system 102, in the example forms a network-based publication system that provides server-side functionality, via a network 104 (e.g., the Internet or Wide Area Network (WAN)) to one or more clients. FIG. 1 further illustrates, for example, a web client 106 (e.g., a browser, such as the Internet Explorer browser developed by Microsoft Corporation of Redmond, Washington), and a programmatic client 108 executing on respective client machines 110 and 112. In one embodiment, the publication system comprises a marketplace system. In another embodiment, the publication system comprises other types of systems such as, but not limited to, a social networking system, an information retrieval system, and the like.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and may equally well find application in a distributed, or peer-to-peer, architecture system, for example. The various marketplace and payment applications 120 and 122 may also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

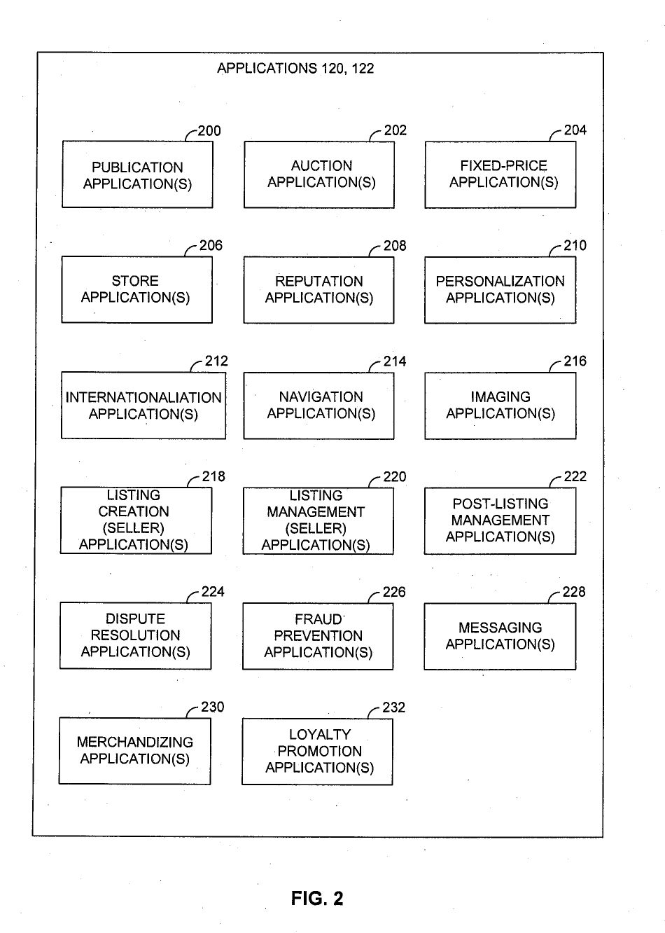

FIG. 2 illustrates a block diagram of additional details of applications 120 and 122 according to some embodiments. Applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications or so as to allow the applications to share and access common data. The applications may furthermore access one or more databases 126 via the data servers 128.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users that transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing images that users may upload for inclusion within listings.. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occurs post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages include, for example, advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and may be offered a reward for which accumulated loyalty points can be redeemed.

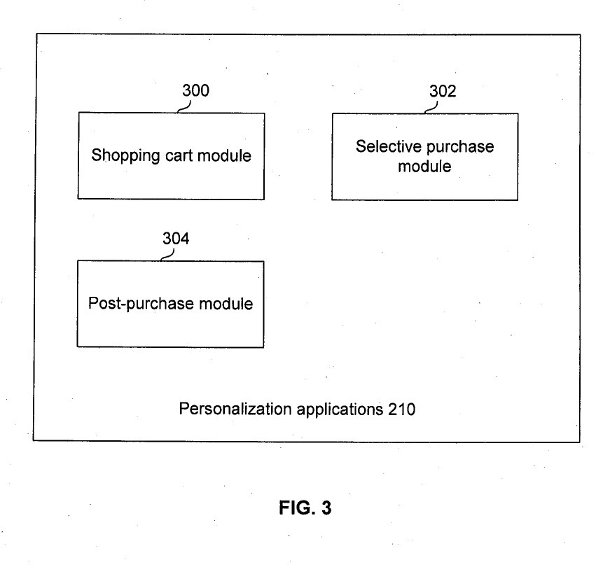

FIG. 3 illustrates a block diagram showing modules included in the personalization applications 210 according to some embodiments. The personalization applications 210 include a shopping cart module 300, a selective purchase module 302, and a post-purchase module 304. Although modules 300-304 are shown as distinct modules in FIG. 3, it should be understood that modules 300-304 may be implemented as fewer or more modules than illustrated. It should also be understood that any of modules 300-304 may communicate with one or more components included in networked system 102, such as database servers 124, API server 114, or web server 116.

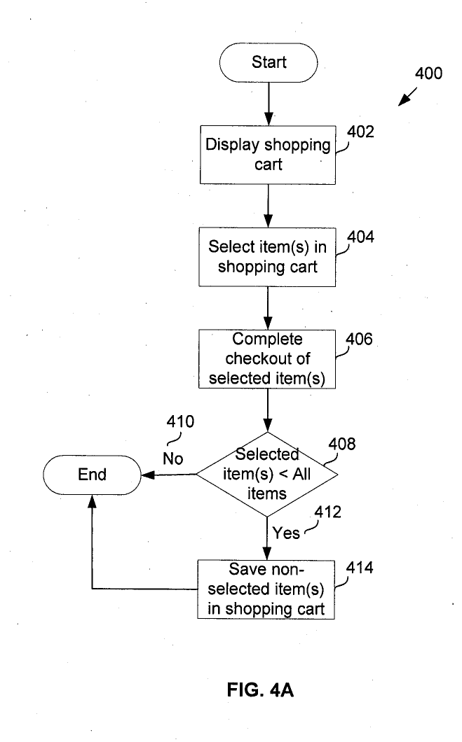

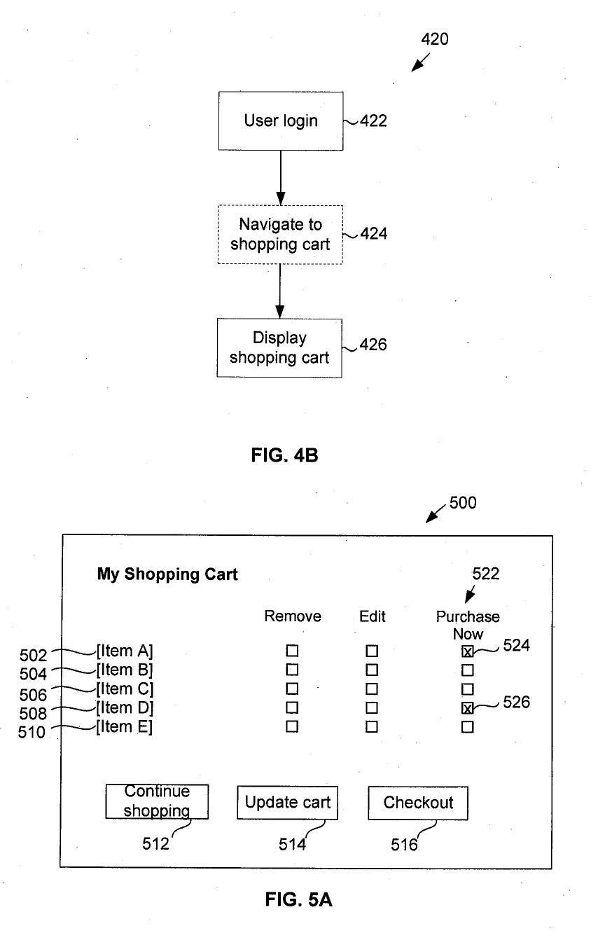

FIG. 4A illustrates an exemplary flow diagram 400 of a method for providing selective checkout of items in a shopping cart according to some embodiments. The flow diagram 400 will be described in conjunction with the modules of FIG. 3. Although not shown, a user interacts with an electronic marketplace, and places one or more items (e.g.; goods and/or services) offered for sale in the marketplace into a virtual shopping cart. The user may place items in a shopping cart as he or she comes across items of interest and/or because he/she wants to buy the item. The user may also remove item(s) and/or edit item(s) (e.g., change quantity, color, or style of the item) in the shopping cart as desired. At a block 402, a shopping cart module 300 is configured to display the virtual shopping cart associated with the user at the user site. The display of the shopping cart may be automatically provided by the shopping cart module 300, or the display may be initiated by the user (e.g., the user clicks on a shopping cart icon provided on the electronic marketplace).

The electronic marketplace comprises a network-based transaction facility that directly offers for sale or hosts offers to sell from third parties. Accordingly, an item offered for sale (directly or indirectly) at the electronic marketplace may be provided by one or more manufacturers, distributers, vendors, sellers, retailers, or the like.

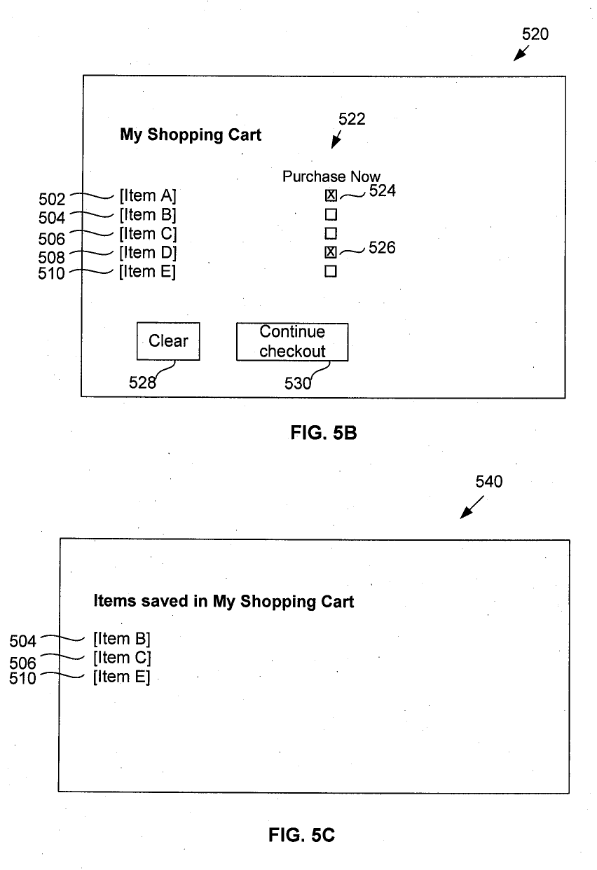

FIG. 5A shows an exemplary shopping cart page 500 displayed to a user according to some embodiments. The shopping cart page 500 provides information about each item in the cart and also provides user interaction options for each of the cart items to facilitate checkout. Item information comprises, but is not limited to, an item name, item number, picture of the item, brief description of the item, quantity of the item specified by the user, a color or style of the item, and the like. User interaction options include, but are not limited to, remove, edit, and purchase now action icons that can be actuated for each item in the cart. FIG. 5A shows, as an example, five items placed into the cart: Item. A 502, Item B 504, Item C 506, Item D 508, and Item E 510. For any of these items, the user can remove the item from the cart, edit the item in the cart (e.g., change the quantity, color, style, configuration, etc.), and/or specify purchasing a particular item in the cart before another item in the cart (to be discussed in detail below). The shopping cart page 500 also provides a continue shopping icon 512, an update cart icon 514 (the user may check a box to remove Item A 502 and then click the update cart icon 514 to complete the remove action), and a checkout icon 516. The continue shopping icon 512 may be used by the user to continue shopping in the electronic marketplace and perhaps add more item(s) to the shopping cart. The user may check a box to remove or edit, for example, Item A 502 and then click on the update cart icon 514 to complete the remove or edit action. The user may click on the checkout icon 516 when the user is ready to purchase at least one item, as is, in the shopping cart.

In one embodiment, the user can specify fewer items for purchase than are currently in the shopping cart without removing the non-specified items from the shopping cart (block 404). The selective purchase module 302 is configured to permit the user to selectively initiate purchase of certain item(s) in the cart rather than requiring all items in the cart to be purchased. By providing such a selective checkout feature, the user can purchase only those items that the user is currently ready to buy. The non-selective items in the cart can remain in the cart for later and additional consideration by the user. In this manner, items that may have been added to the cart because the user was interested in an item, even if the user was not necessarily ready to buy those items, need not be deleted from the shopping cart before checkout can commence. This increases the efficiency of the checkout process, decreases the chance that an unwanted item is inadvertently purchased, and automatically provides a list of items of interest for subsequent visits to the electronic marketplace.

For example, the shopping cart page 500 may include a purchase now icon 522, such as a check box for each of the respective items 502-510, that the user can selectively actuate to specify items to purchase now. In FIG. 5A, the user has selected Item A 502 and Item D 508 for immediate purchase by checking respective boxes 524 and 526 included in the purchase now icon 522. Then the user can proceed to checkout by clicking on the checkout icon 516.

In another example, the purchase now icon 522 may be included in a subsequent shopping cart page after the checkout process has already started. The purchase now icon 522 may be provided in a shopping cart page 520 (FIG. 5B) that is displayed to the user after the shopping cart page 500, rather than providing the purchase now icon 522 in the shopping cart page 500. Again, FIG. 5B shows boxes 524 and 526 checked by the user to selectively purchase Item A 502 and Item D 508. The user may then click on a continue checkout icon 530 to proceed to a shipping address page, payment page, and the like.

In still another example, the purchase now icon 522 may be provided in each of the shopping cart pages 500 and 520. Where and how many times the purchase now icon 522 is provided during the checkout process is a design choice depending on what user behavior to influence and/or the buying experience desired by the marketplace. If, for example, the marketplace desires to provide as many chances as possible for the user to select items from within the cart, then the purchase now icon 522 may be provided more than once during the checkout process. On the other hand, if the primary desire is to streamline the checkout process as much as possible, the purchase now icon 522 may be provided just once during the checkout process.

It should also be understood that the layout of navigation/interaction icons in the shopping cart pages are not limited as depicted in FIGS. 4A and 4B. The purchase now icon 522, for example, may be provided to the left of the items 502-510. As another example, the purchase now icon 522 can comprise radio buttons or the like rather than check boxes.

Any one or more items in the shopping cart can be selected by the user for checkout. As an example; Item A 502 may be a sweater and Item D 508 may be a compact disc. As another example, Item A 502 may be a sweater offered for sale by a seller A and Item D 508 may be an identical sweater except it is being offered for sale by a different seller D. In still another example, Item A 502 may be a sweater in a blue color while Item D 508 is the identical sweater except it is in the color red.

Once the user selects one or more items in the shopping cart, the selective purchase module 302 facilitates presentation of the rest of the checkout page(s) to complete an order of such user-selected items (block 406). The user is presented one or more pages (also referred to as an order or ordering interface) (not shown) to enter and/or verify shipping address, payment information, authorize payment, gifting information, and the like. If the user hasn't logged in or the system is otherwise unable to uniquely identify the user, the user may be asked to enter a username and password before, during, or after the checkout process. Such information may be required to complete a purchase, aids in auto-filling information to complete a purchase (e.g., retrieving the user's account for a stored shipping address, credit card number, etc.), and/or used to save the non-selected item(s) in the shopping cart for subsequent use by the user. In some embodiments, the shopping cart may permit the user to complete checkout of an item (also referred to as ordering an item) without requiring payment at the time of checkout. The user may, for example, mail in a check or money order after checkout.

Next, a check is performed to determine if the user-selected items that were just purchased are all the items in the shopping cart (block 408). If all the items in the shopping cart were selected (no branch 410), then there are no remaining item(s) in the cart to be retained for subsequent use. Otherwise there is one or more items left in the shopping cart (yes branch 412), and those items are automatically saved and associated with the user for subsequent use (block 414). The post-purchase module 304 is configured to track the non-selected items remaining in the shopping cart and to associate them with the user's account in the system. The selective purchase module 302 and/or the post-purchase module 304 may track the user's selections at all time so that the system can continuously track selected vs. non-selected items in the user's shopping cart. The selected item(s) for which an order was completed in the block 406 are removed from the user's shopping cart, while the non-selected item(s) are maintained in the user's shopping cart.

FIG. 5C illustrates an exemplary page 540 showing non-selected items left in the user's shopping cart after checkout of the selected items has been completed according to some embodiments. Page 540 comprises, continuing the example started in pages 500 and/or 520, presentation of Item B 504, Item C 506, and Item E 510 with optional explanation of why these items are in the user's shopping cart. Page 540 can also include a remove icon, an edit icon, a purchase now icon, checkout icon, etc. for each item in the cart as shown in FIG. 5A or 5B, as appropriate. Page 540 represents at least a portion of the user's shopping cart, checkout summary page, or the like.

In one embodiment, the page 540 is displayed to the user upon completion of checkout of the user-selected item(s). It serves as a summary or reminder of the items remaining in the shopping cart. In another embodiment, the page 540 is displayed to the user when a shopping cart is displayed to the user, such as in block 426 of FIG. 4B discussed below, assuming that the items are still the most up-to-date remaining items in the user's shopping cart (e.g., the user hasn't purchased one or more items from these remaining items, the user hasn't removed one or more items from these remaining items, etc.).

Although FIG. 4A shows saving the non-selected items (block 414) after ordering the selected items (block 406), it is contemplated that block 414 may be performed as soon as the user has selected items for immediate checkout.

FIG. 4B illustrates an exemplary flow diagram 420 for subsequent access to the remaining items (also referred to as the non-selected items) in the shopping cart according to some embodiments. The next time the user logs into the electronic marketplace after buying the selected items from the marketplace (block 422), the user is automatically presented with a shopping cart page that provides the non-selected items (block 426) or the user can navigate (block 424) within the marketplace to view his/her shopping cart that includes the non-selected items (block 424). The post-purchase module 304 and the shopping cart module 300 together provide this functionality.

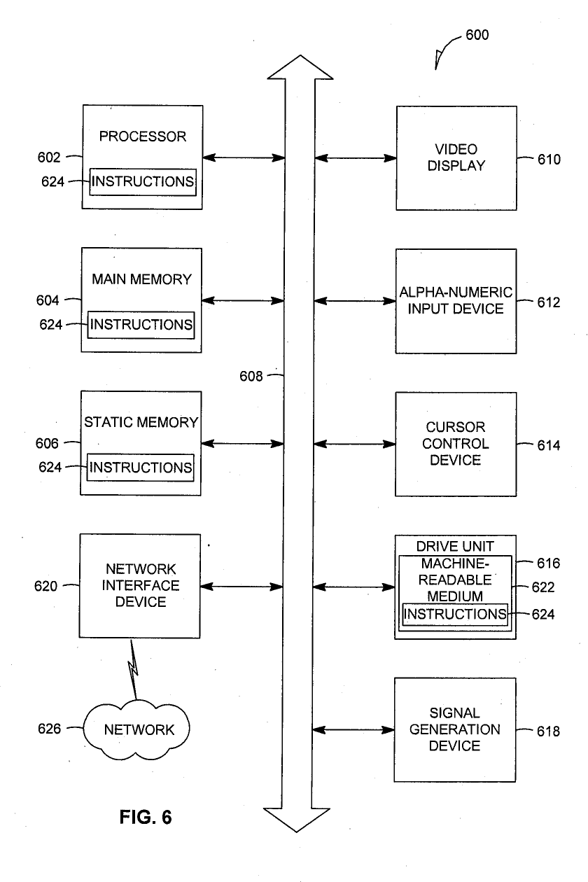

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions 624 (e.g., software) embodying any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to browse an electronic marketplace, place items of interest into a shopping cart, selectively purchase one or more items in the shopping cart without having to remove the non-selected items from the shopping cart, and automatically retain the non-selected items in the shopping cart for future access has been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for purchasing items in an electronic marketplace, the method comprising:
receiving, at a processor of a machine, a selection to purchase a first item from among a plurality of items in a shopping cart;
providing an order interface for completion of a purchase of the first item; and
automatically saving remaining items in the shopping cart for subsequent access by a user, the remaining items including the plurality of items excluding the first item.

2. The method of claim 1, further comprising receiving an indication by the user to add each of the plurality of items to the shopping cart prior to the receiving of the selection of the first item.

3. The method of claim 1, wherein the providing the order interface includes the user ordering the first item without removing the remaining items from the shopping cart.

4. The method of claim 1, wherein the first item comprises a good or service.

5. The method of claim 1, further comprising receiving a selection to purchase a second item from the user from among the plurality of items in the shopping cart, the second item being different from the first item, and wherein the providing the order interface comprises providing the order interface for the user to simultaneously order the first item and the second item excluding any of the plurality of items not selected.

6. The method of claim 1, further comprising presenting to the user a subsequent shopping cart including the remaining items.

7. The method of claim 1, further comprising automatically associating the remaining items with an account of the user.

8. A non-transitory computer readable medium including instructions, which when executed by a processor of a machine, causes the machine to perform operations comprising:
receiving a selection to purchase a first item from among a plurality of items in a shopping cart;
providing an order interface for completion of a purchase of the first item; and
automatically saving remaining items in the shopping cart for subsequent access by a user, the remaining items including the plurality of items excluding the first item.

9. The computer readable medium of claim 8, wherein the operations further comprise receiving an indication by the user to add each of the plurality of items to the shopping cart prior to the receiving of the selection of the first item.

10. The computer readable medium of claim 8, wherein the providing the order interface includes the user ordering the first item without removing the remaining items from the shopping cart.

11. The computer readable medium of claim 8, wherein the first item comprises a good or service.

12. The computer readable medium of claim 8, wherein the operation further comprise receiving a selection to purchase a second item from among the plurality of items in the shopping cart, the second item being different from the first item, and wherein the providing the order interface comprises providing the order interface for the user to simultaneously order the first item and the second item excluding any of the plurality of items not selected.

13. The computer readable medium of claim 8, wherein the operations further comprise presenting to the user a subsequent shopping cart including the remaining items.

14. The computer readable medium of claim 8, wherein the operations further comprise automatically associating the remaining items with an account of the user.

15. A system, comprising:
a storage device including instructions to provide a shopping cart and an order interface for an electronic marketplace; and
a computing device in communication with the storage device and configured to execute the instructions to perform operations comprising:
receiving a selection to purchase a first item from among a plurality of items in the shopping cart,
providing the order interface for completion of a purchase of the first item, and
automatically saving remaining items in the shopping cart for subsequent access by a user, the remaining items including the plurality of items excluding the first item.

16. The system of claim 15, wherein the computing device is configured to provide the order interface for the user to order the first item while the remaining items remain in the shopping cart.

17. The system of claim 15, wherein the computing device is configured to automatically associate the remaining items with a user's shopping cart.

18. The system of claim 15, wherein the computing device is configured to receive a selection to purchase a second item from among the plurality of items in the shopping cart, the second items being different from the first item.

19. The system of claim 18, wherein the computing device is configured to provide the order interface for the user to simultaneously order the first item and the second item excluding any of the plurality of items not selected.

20. The system of claim 15, wherein the order interface includes a payment authorization from the user of the first item.

21. The system of claim 15, wherein the first item comprises a good or service offered by the electronic marketplace.
